(19) United States
(12) Patent Application Publication
(10) Pub. No.: US 2017/0290349 A1
(43) Pub. Date: Oct. 12, 2017

(54) PROCESS FOR COMBATING BACTERIA AND FURTHER BACTERIA GROWTH IN MEAT

(71) Applicants: Terry Wayne Hammonds, Atlanta, GA (US); Jerrill Hampton Sprinkle, Johns Creek, GA (US)

(72) Inventors: Terry Wayne Hammonds, Atlanta, GA (US); Jerrill Hampton Sprinkle, Johns Creek, GA (US)

(21) Appl. No.: 15/485,678

(22) Filed: Apr. 12, 2017

Related U.S. Application Data
(60) Provisional application No. 62/321,568, filed on Apr. 12, 2016.
(60) Provisional application No. 62/355,384, filed on Jun. 28, 2016.

(51) Int. Cl. A23B 4/22

(52) U.S. Cl. CPC A23B 4/22; A23V 2002/00

(57) ABSTRACT

A method for combating bacteria and the further growth of bacteria in meat comprising: treating MSC, MDM, MSP, ground in poultry, turkey, beef, or pork with a granular additive, gel additive or paste additive,

### RELATED APPLICATIONS

The present application is based on provisional patent application Ser. No. 62/321,568 filed Apr. 12, 2016 and provisional patent application Ser. No. 62/355,384 flied Jun. 28, 2016.

### FIELD OF THE INVENTION

The present invention relates to a process for combating bacteria and further growth of bacteria in meat.

### BACKGROUND OF THE INVENTION

U.S. Pat. No. 3,934,044 relates to a process for treating meat and meat-cuts to destroy surface bacteria, and spoilage bacteria comprising contacting meat surfaces with a hot aqueous acid solution for a time sufficient to achieve substantial surface bacterial kill but insufficient to result in any appreciable organoleptic deterioration of the meat.

U.S. Pat. No. 4,147,807 relates to a process for improving a superior flavor in fermented meat, using Micrococcus varians in admixture with Pediococcus cerevisiae and/or with other lactic acid producing meat fermenting bacteria for lowering the pH.

U.S. Pat. No. 4,303,679 relates to a method and bacterial compositions for producing fermented meat by generating lactic acid using selected cultures of Pediococcus pentosaceus which have unique low temperature meat fermentation characteristics.

U.S. Pat. No. 4,756,919 relates to fumaric acid used alone or in combination with a food acidulent to preserve acid containing food products from lactic acid bacteria microbiological spoilage in the absence of or at reduced levels of chemical preservatives.

U.S. Pat. No. 4,810,508 relates to a process for the preparation of foods of animal origin wherein efficacious quantities of lysozyme or its nontoxic salts are added to the foods for the purpose of obtaining foods free of Listeria bacteria.

U.S. Pat. No. 5,374,433 relates to a method for preserving a food product such as meat. The method comprises the steps of inoculating meat with an effective amount of euhygienic, non-pathogenic, non-spoilage bacteria in order to competitively inhibit the growth of undesired pathogenic and spoilage bacteria. Bacteria present on a meat product is first reduced by spraying the meat with an organic acid prior to inoculation.

U.S. Pat. No. 5,573,801 relates to an antimicrobial composition comprising a Streptococcus derived or Pediococcus derived bacteriocin or synthetic equivalent antibacterial agent in combination with a chelating agent.

U.S. Pat. No. 5,639,466 relates to an antimicrobial composition and method for use in packaging of moisture containing foodstuffs in a manner to extend the shelf life of the foods that comprises placing the foodstuffs in intimate contact with a composition which comprises 5-40% wt. of lactic acid based composition or a lactic acid copolymer.

U.S. Pat. No. 7,435,438 relates to a process for treating food products, comprising applying an aqueous disinfectant solution comprising silver dihydrogen citrate.

U.S. Pat. No. 8,916,510 relates to a method for treating food products by applying an antimicrobial composition and processing the food product. The antimicrobial composition is applied to the surface of the meat or poultry product, and the meat or poultry product is processed using a chemical or mechanical tenderizer.

U.S. patent publication 2004/0025715 relates to anaerobic digestion of animal manures, energy crops and similar organic substrates. The process processes animal carcasses including meat and bone meal. The risk of spreading BSE prions or any other prions to animals or humans is reduced. The biogas and slurry separation system is integrated with the animal husbandry.

U.S. patent publication 2004/0156925 relates to isolation and identification of plant proanthocyanidin extracts and compounds for prevention and treatment of urinary tract infections caused by P-type E-coli. The extracts and compounds are provided in ground meat preparations. The invention relates to reducing E-coli contamination in ground meat and detecting P-type bacteria.

U.S. patent publication 2005/0058751 relates to a process for treating meat to achieve higher yield. The process comprises treating the meat by injection with a higher pH phosphate solution having a pH of above 6.0 and then contacting the meat by dipping or spraying a lower pH solution with pH below 5.6.

U.S. patent publication 2005/0129815 relates to controlling or destroying bacterial growth in a food substance by applying to the substrate an aqueous acidic protein solution isolated from animal muscle tissue and/or a peptide derived from the protein.

U.S. patent publication 2005/0175745 relates to a method of preserving a food product from deterioration due to microbial growth and oxidation of any constituent fats or oils which may be present within said food product comprises adding to the food product one or more phytosterols, phytostanols or mixtures thereof.

U.S. patent publication 2006/0099311 relates to the use of glycine or glycine derivatives as antimicrobial agent in fresh meat. It is especially suitable for the preservation of fresh meat against E. Coli, Salmonella, and Campylobacter. Preferably, glycine and/or its derivatives is used as sole antibacterial agent in fresh meat.

U.S. patent publication 2007/0264398 relates to an antimicrobial, anti-bacterial processing aid, food additive and food ingredient is provided to inhibit cellular growth of known pathogenic, indicator and spoilage organisms, such as salmonella, staphylococcus, listeria, e coli and the like. This is useful as a treatment for cooked food. The antimicrobial agent inhibits growth of bacteria that have become antibiotic resistant.

U.S. patent publication 2008/0095897 relates to processed meat products and methods of making the same. The methods include incorporating a powder-like substance comprising an oil comprising a long chain polyunsaturated fatty acid into a processed meat product.

U.S. patent publication 2011/0086146 relates to a method and composition for reducing microbes during a meat processing operation. The composition includes an acid blend that is a blend of an organic acid selected from the group consisting of lactic acid, acetic acid, and mixtures thereof; and a second material selected from the group consisting of alkali metal salts of an inorganic acids, mineral adds, and mixtures thereof.

U.S. patent publication 2015/0272145 relates to a method for preparing raw meat or raw seafood that is resistant to spoilage comprising: a) incubating a solution comprising a population of non-pathogenic psychotropic lactic acid bacteria for a period of time to enable growth to form a culture to prevent spoilage; (b) adding a saccharide to the bacterial culture and incubating, wherein the saccharide is present in amount sufficient to achieve bacteriostasis of culture; admixing bacterial culture formed in step b) with raw meat or seafood.

U.S. patent publication 2015/0342197 relates to an antimicrobial compositions and their use in the treatment of products such as food products. The composition comprises a bacteriophage endolysin and an antimicrobial compound.

U.S. patent publication 2016/0029667 relates to a process for producing a meat slurry. The process includes (i) obtaining an animal source of protein; (ii) reducing piece size of animal source of protein to produce a smaller piece sized animal source of protein; (iii) introducing one or more types of lactic acid producing bacteria and at least one carbohydrate energy source to the smaller piece sized animal source of protein to produce a meat mixture; (iv) adding water to the meat mixture to produce an activated meat mixture; (v) incubating the activated meat mixture to produce a meat slurry.

### SUMMARY OF THE INVENTION

The present invention relates to combating bacteria and the further growth of bacteria in meat. The present invention relates to the treating of MSC (mechanically separated chicken), MDM (mechanically deboned meat), MSP (mechanically separated pork), ground in poultry, turkey, beef, or pork with a granular additive, gel additive or paste additive. It is an object of the present invention for the granular additive, gel additive or paste additive to be selected from the group consisting of: PAA (peracetic acid), sodium per-carb, citric acid, lactic acid, NISIN (a polycyclic antibacterial peptide produced by the bacterium Lactococcus lactis), EDTA (Ethylenediaminetetraacetic acid), acetic acid, usda approved antimicrobial or blends thereof.

It is an object of the present invention for the granular additive, gel additive or paste additive to be used as an antimicrobial or processing aid.

It is an object of the present invention for the granular additive, gel additive, or paste additive to be placed with the MSC, MDM or MSP in a blender, mixer, or grinder to form a solution.

It is an object of the present invention for the granular additive, gel additive or paste additive to reduce salmonella, campylobacter, E. coli, APC (anaerobic plate count) and TPC (total plate count).

### DETAILED DESCRIPTION OF THE INVENTION

A granular additive, gel additive or paste additive used for combating bacteria and the further growth of bacteria in meat. The granular additive, gel additive or paste additive is used to treat MSC (mechanically separated chicken), MDM (mechanically deboned meat), MSP (mechanically separated pork), ground in poultry, turkey, beef, or pork.

The granular additive, gel additive or paste additive is selected from the group consisting of: PAA (peracetic acid), sodium per-carb, citric acid, lactic acid, NISIN (a polycyclic antibacterial peptide produced by the bacterium Lactococcus lactis), EDTA (Ethylenediaminetetraacetic acid), acetic acid, approved usda antimicrobial, or blends thereof.

The granular additive, gel additive or paste additive to be used as an antimicrobial or processing aid.

The granular additive, gel additive, or paste additive is placed with the MSC, MDM or MSP in a blender, mixer, or grinder to form a solution.

The granular additive, gel additive or paste additive reduces salmonella, campylobacter, E. coli, APC (anaerobic plate count) and TPC (total plate count).

During the blending, mixing or grinding, the granular additive, gel additive or paste additive is applied directly to the MSC, MDM, MSP, and ground products at a percentage of approximately 0.1% to 5% of additive to approximately 99.9% to 95% of meat product. The mixing/blending time is approximately 25 seconds to 20 minutes. After blending the treated MSC, MDM MSP or ground product is packaged and is ready for sale for human consumption.

1. A method for combating bacteria and the further growth of bacteria in meat comprising:
treating MSC, MDM, MSP, ground in poultry, turkey, beef, or pork with a granular additive, gel additive or paste additive;
said granular additive, gel additive or paste additive selected from the group consisting of: PAA (peracetic acid), sodium per-carb, citric acid, lactic acid, NISIN (a polycyclic antibacterial peptide produced by the bacterium Lactococcus lactis), EDTA (Ethylenediaminetetraacetic acid), acetic acid, approved usda antimicrobial, or blends thereof;
placing said granular additive, gel additive, or paste additive with said MSC, MDM, MSP, ground in poultry, turkey, beef or pork in a blender, mixer, or grinder to form a solution;
blending mixing or grinding said granular additive, gel additive or paste additive with said MSC, MDM, MSP, ground in poultry, turkey, beef or pork;
reducing salmonella, campylobacter, E. coli, APC (anaerobic plate count) or TPC (total plate count) or any combination.

2. The method of claim 1 wherein said granular additive, gel additive or paste additive is used as an antimicrobial or processing aid.

3. The method of claim 1 wherein during said blending, mixing or grinding, said granular additive, gel additive or paste additive is applied directly to said the MSC, MDM, MSP, and ground poultry, turkey, beef or pork at a percentage of approximately 0.1% to 5% of additive to approximately 99.9% to 95% of meat product.

4. The method of claim 1 wherein said mixing, blending or grinding time is approximately 25 seconds to 20 minutes.

5. The method of claim 1 wherein after blending, mixing or grinding the treated MSC, MDM MSP or ground product is packaged and is ready for sale for human consumption.
